(19) United States
(12) Patent Application Publication
(10) Pub. No.: US 2004/0120168 A1
(43) Pub. Date: Jun. 24, 2004

(54) Split-package AC adapter

(75) Inventor: Marshall Miles, Oklahoma City, OK (US)

Correspondence Address: OSTROLENK, FABER, GERB & SOFFEN, LLP, 1180 Avenue of the Americas, New York, NY, 10036-8403, US

(73) Assignee: Bel-Fuse

(21) Appl. No.: 10/729,183

(22) Filed: Dec. 4, 2003

Related U.S. Application Data
(63) Continuation of application No. 10/282,803, filed on Oct. 24, 2002, now abandoned.

(51) Int. Cl. H02M 1/12

(52) U.S. Cl. 363/44

(57) ABSTRACT

The power adapter includes an AC input receptacle which plugs into an AC power socket. The AC input receptacle is connected to an input of a voltage converting circuit which converts the input AC voltage into a DC voltage. The voltage converting circuit is contained within a first housing, and the AC input receptacle projects from the first housing such that it can be easily connected to a wall socket. A first cable is connected to the output of the voltage converting circuit and runs from the first housing to an input of a voltage regulating circuit which is contained within a second housing remote from the first housing. The voltage regulating circuit maintains and outputs the DC voltage within a desired range. The output from the voltage regulating circuit is connected to respective prongs of an electrical device connector via a second cable.

### CROSS REFERENCE TO RELATED APPLICATION

This application is a continuation application of Ser. No. 10/282,803, filed Oct. 24, 2004 entitled “SPLIT-PACKAGE AC ADAPTER” which application claims the benefit and priority of U.S. Provisional Application Serial No. 60/242,900, filed Oct. 24, 2000 entitled “SPLIT-PACKAGE AC ADAPTER” the disclosure of which is incorporated herein by reference.

### BACKGROUND OF THE INVENTION

The present invention relates to AC power adapters, particularly AC power adapters for use in any number of fields, such as consumer, commercial, industrial and medical electronics. More particularly, the present invention relates to an AC power adapter with a DC output.

Many different electronic devices are powered by direct-current (DC) voltage, as well as alternating-current (AC) voltage. However, standard line voltage available from wall outlets is AC. Therefore, the AC voltage must be converted to a DC voltage by an AC adapter to be used in these electronic devices.

AC adapters convert AC voltage (for example, 110 volts at 60 Hertz) from a standard wall outlet to a DC voltage (for example, 12 volts) which is useable by an electronic device, such as a mobile phone, a printer, a video game, and so on.

AC adapters generally include a plug which plugs into a wall outlet, a transformer which steps the line voltage down, a rectifier circuit which rectifies the stepped-down AC voltage to a DC voltage, and a plug which plugs into an electronic device. Numerous types of adapters have been developed, each having a rated voltage for a particular device and each having a plug which has a particular configuration engageable with a compatible socket of that particular device. Accordingly, separate AC adapters are typically provided for each electronic device.

A typical power adapter includes an AC input receptacle which plugs into an AC power socket and a power converter circuit. The power converter circuit includes a voltage converting portion for converting an input AC voltage to a DC voltage and a voltage regulating portion for maintaining and outputting the DC voltage within a desired range. The voltage converting portion typically includes such components as a fuse, an inrush resistor, a common mode choke, a high frequency filter and a rectifying circuit. The voltage regulating portion typically includes such components as a transformer (wound coil) and a bulk capacitor. The power converter circuit, including both the voltage converting portion and the voltage regulating portion, is contained within a single housing. The AC input receptacle projects from the housing such that it can be easily connected to a wall socket. The output portion of the power converter circuit is then connected to respective prongs of an electrical device connector via an output cable.

Because of this output power adapter design, the housing portion of the adapter which plugs into an AC power socket and contains the power converter circuit is relatively large. Further, since all of the components are located in the same housing, relatively long output wires are required to be run from the circuitry within the housing to the prongs of the electrical device connector. Because relatively long wires are used, this power adapter consumes a relatively large amount of power and has a higher voltage drop from the housing to the device connector, thereby decreasing the efficiency of the power adapter. Moreover, due to the design of the power converter circuit, the circuit occupies a large volume, has a large power consumption, low efficiency, poor output regulation, and a high manufacturing cost.

Accordingly, there remains a need for a power adapter which is simple in design, inexpensive to manufacture and is highly efficient.

### SUMMARY OF THE INVENTION

The present invention provides a power adapter which is simple in structure, can be produced at a lower cost, operates with a higher efficiency and has a better output performance than the prior art power adapters.

The power adapter of the present invention includes an AC input receptacle which plugs into an AC power socket. The AC input receptacle is connected to an input of a voltage converting circuit which converts the input AC voltage into a DC voltage. The voltage converting circuit is contained within a first housing, and the AC input receptacle projects from the first housing such that it can be easily connected to a wall socket. A first cable is connected to the output of the voltage converting circuit and runs from the first housing to an input of a voltage regulating circuit. The voltage regulating circuit is contained within a second housing remote from the first housing. The voltage regulating circuit maintains and outputs the DC voltage within a desired range. The output from the voltage regulating circuit is connected to respective prongs of an electrical device connector via a second cable.

With the above design, a power adapter is provided which has a relatively simple structure, a high efficiency and improved output performance. Moreover, because the first housing need only contain the voltage converting circuit, the power adapter has increased thermal performance and improved electromagnetic interference characteristics.

Additionally, since the power converter circuit electronics are separated from the input connector style (for example, 110V_{AC}, 220V_{AC}), which vary by geography throughout the world, production costs can be reduced because each of the input connectors and the voltage regulating circuits can be separately manufactured and then matched to form the desired power adapter. For example, with the prior art power adapters, if there were five different input connector styles and 5 different output voltages required, 25 different connectors would have to be produced (5 input connectors×5 required output voltages). With the present power adapter, the five different input connectors could be produced separately from the five voltage regulating portions. Then, the desired input connector style can be matched to desired voltage regulating portion. Thus, only 10 separate items need be manufactured (5 input connector styles+5 voltage regulating portions).

### BRIEF DESCRIPTION OF THE DRAWING(S)

Other features and advantages of the present invention will become apparent from the following description of the invention which refers to the accompanying drawings, wherein:

FIG. 1 is a diagram of the power adapter according to a preferred embodiment of the present invention;

FIG. 2 is a schematic diagram of the voltage converting circuit and the voltage regulating circuit according to a preferred embodiment of the present invention; and

FIG. 3 shows an electronic device connector for the power adapter of FIG. 1.

### DETAILED DESCRIPTION OF PREFERRED EMBODIMENTS OF THE INVENTION

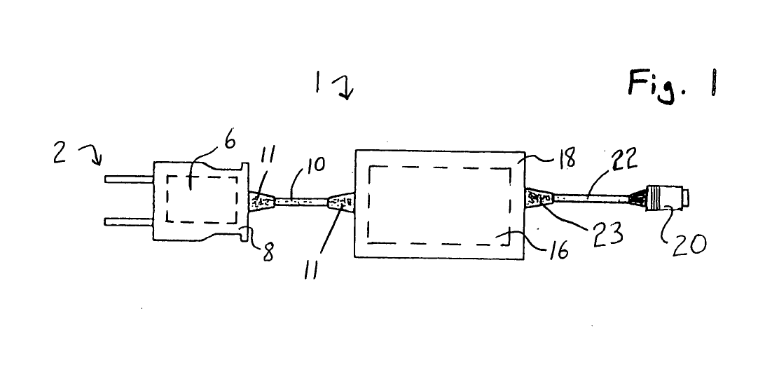

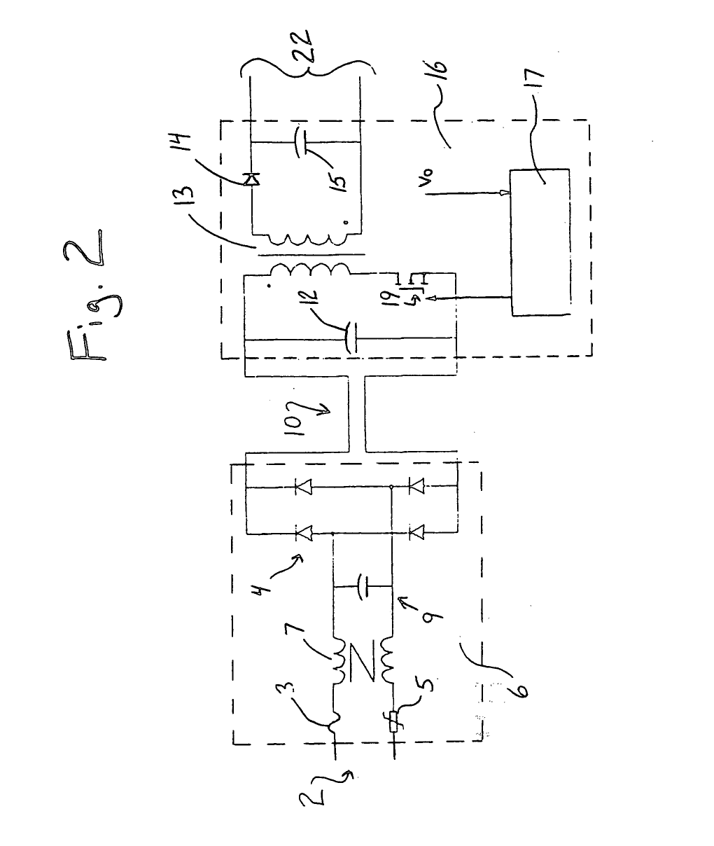

Referring now to the drawings, FIGS. 1 and 2 show the multiple output power adapter of the present invention, generally referred to as 1. The multiple output power adapter 1 includes an AC input receptacle 2 which plugs into an AC power socket (not shown).

The AC input receptacle 2 is connected to an input of a voltage converting circuit 6. The voltage converting circuit 6 converts the input AC voltage into a DC voltage. The voltage converting circuit 6 can be a simple rectifier circuit containing a single diode, a half-wave rectifier, a full-wave rectifier, such as for example, a bridge rectifier having four rectifiers in the form of a bridge, with the AC supply connected across one diagonal and the DC output taken from the other diagonal, or the like. The preferred embodiment shown in FIG. 2 shows a full-wave bridge-rectifier 4. Further, the voltage converting circuit 6 may include, as shown in FIG. 2, a fuse 3, an inrush resistor 5, a common mode choke 7 and a high frequency filtering capacitor (EMI filter) 9. The choice of the particular components for the voltage converting circuit 6 will be apparent to one of skill in the power adapter art and dependent upon the AC-DC conversion characteristics required of the power adapter.

The voltage converting circuit 6 is contained within a first housing 8, and the AC input receptacle 2 projects from the first housing 8 such that it can be easily connected to a wall socket (not shown). A first cable 10 is connected to an output of the voltage converting circuit 6 and runs from the first housing 8 to an input of a voltage regulating circuit 16 as shown in FIG. 2. The first cable 10 preferably comprises two wires, each of which are respectively connected to the plus (+) and minus (−) voltage outputs of the voltage converting circuit 6.

The voltage regulating circuit 16 is preferably contained within a second housing 18 remote from the first housing 8. The voltage regulating circuit 16 maintains and outputs the DC voltage within a desired range. The DC voltage is output from respective output terminals of the voltage regulating circuit 16 as shown in FIG. 2. Preferably, the voltage regulating circuit 16 includes a capacitor 12 which operates as the main energy storage component, a transformer 13, a diode 14, a capacitor 15 connected across the output voltage positive and negative terminals, control circuitry 17 and a switching transistor 19. The control circuitry monitors the output voltage V_{O} and operates the switching transistor 19 to maintain the output DC voltage, in conjunction with the transformer 13, within a desired range. Preferably, the control circuitry 17 includes an IC to perform these functions, and the switching transistor is preferably an FET. With this arrangement, the control circuitry 17 can be modified or changed so as to change the characteristics of the voltage regulating circuit.

With the separation of the voltage converting circuit from the voltage regulating circuit in the manner described above, the thermal performance of the power adapter may be increased. This is because the inrush resistor, the common mode choke and the rectifier circuit typically dissipate a total of about 3-4% of the output power, or about 30% of the total power dissipation of the power adapter, under worst case thermal operating conditions (i.e., 90 V_{AC} and full load). Therefore, the split-package design (i.e., two separate housings for the voltage converting circuit and the voltage regulating circuit) may reduce the heat produced in the second housing 18 by about 30%. Accordingly, the size of the second housing can be reduced by 30% also.

Further, the electromagnetic interference properties (EMI) of the power adapter are also improved with the present split-package design. Because the high frequency filter (EMI filter) and the main power stage components (i.e., the power transformer) are contained in separate housings, there is less coupling between these respective components.

Preferably, the first housing is formed by overmolding the voltage converting circuit components with the first housing. This is preferably for small form factor AC plugs, such as those used in the US. For larger form factor plugs (i.e., for the UK), the first housing is preferably formed as a separate plastic case which surrounds the voltage converting circuit components. Likewise, for low power adapters (i.e., 30W or less), the second housing may be overmolded with the voltage regulating circuit components or, for high power adapters, the second housing may be a separate plastic case which surrounds the voltage regulating circuit components.

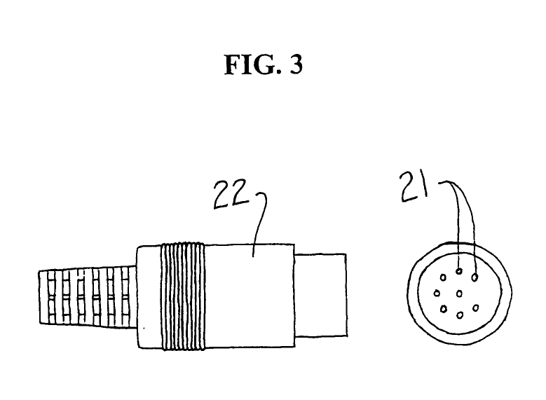

The output from the voltage regulating circuit 16 is connected to respective prongs 21 of an electrical device connector 20 via a second cable 22. The second cable 22 preferably comprises two output wires, each of which is respectively connected to the plus (+) and minus (−) voltage outputs of the voltage regulating circuit 16. The electrical device connector 20 typically includes at least two prongs (i.e., one for each of the output wires of the cable 22). The electrical device connector 20, however, may include more than two prongs, such as the eight prongs 21 shown in FIG. 3. The use of more than two prongs allows more current to be carried to the electronic device through the use of multiple ground and multiple current prongs. Further, the respective prongs of the electrical device connector 20 can be either male or female connectors, the selection of which will depend upon the particular application of the power adapter. When the electrical device connector 20 is plugged into the electrical device (not shown), the DC voltage is supplied to the electrical device. The electrical device connector 20 shown in FIG. 3 is but one example of a connector style which may be used in conjunction with the present invention. Many electrical device connector styles are known, and the choice of any particular style will depend upon the device to which the power adapter is to be used.

Returning to FIG. 1, the first cable 10 may employ plugs/jacks 11 at respective ends thereof so that the AC input receptacle style used in the first housing 8 can be easily interchanged with different second housings 18, and vice versa. Likewise, the second cable 22 may also employ a plug/jack 23 at an end thereof so that the connector style can be easily interchanged.

When the power adapter is configured in the manner described above, the power adapter of the present invention consumes less power and has a lower voltage drop along the output wires of the second cable 22 because they are run a shorter distance from the second housing to the electrical device connector, thereby increasing the efficiency of the power adapter. All of the above factors enable the power adapter of the present invention to be produced at a low manufacturing cost.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A power adapter comprising:
a first housing;
a second housing remote from the first housing;
an AC input receptacle provided in the first housing;
a voltage converting circuit enclosed within the first housing and electrically connected to the AC input receptacle, the voltage converting circuit converting input AC power into a DC voltage; and
a voltage regulating circuit electrically connectable to the voltage converting circuit and enclosed within the second housing, the voltage regulating circuit maintaining and outputting the DC voltage from the voltage converting circuit.

2. The power adapter according to claim 1, further comprising an electrical device connector electrically connectable to the voltage regulating circuit.

3. The power adapter according to claim 2, further comprising:
a means for connecting the voltage converting circuit to the voltage regulating circuit; and
a means for connecting the voltage regulating circuit to the electrical device connector.

4. The power adapter according to claim 3, wherein:
the means for connecting the voltage converting circuit to the voltage regulating circuit comprises a first cable; and
the means for connecting the voltage regulating circuit to the electrical device connector comprises a second cable.

5. The power adapter according to claim 4, wherein the first cable runs from the first housing to the second housing and the second cable runs from the second housing to the electrical device connector.

6. The multiple output power adapter according to claim 1, wherein the voltage converting circuit includes a rectifier.

7. The multiple output power adapter according to claim 6, wherein the rectifier is a full-wave rectifier.

8. The multiple output power adapter according to claim 7, wherein the full-wave rectifier is a bridge rectifier.

9. The power adapter according to claim 1, wherein the voltage converting circuit includes an EMI filter and the voltage regulating circuit includes a transformer.
